(19) United States
(12) Patent Application Publication
(10) Pub. No.: US 2007/0176135 A1
(43) Pub. Date: Aug. 2, 2007

(54) DUAL BUSHING ROD SEAL

(76) Inventors: Mickey HEESTAND, Salem, OH (US); Craig Santini, Salem, OH (US); Rich Somplatsky, Glenshaw, PA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/608,104

(22) Filed: Dec. 7, 2006

Related U.S. Application Data
(60) Provisional application No. 60/763,221, filed on Jan. 30, 2006.

(51) Int. Cl. F16K 31/44

(52) U.S. Cl. 251/214

(57) ABSTRACT

A dual bushing rod seal housed in a balance chamber head. The balance chamber head has opening for receiving the rod. The first bushing a first section disposed between the rod and a counterbore in the balance chamber and a second section disposed between the rod and the inner wall of the balance chamber. The second bushing has a first section disposed between a second counterbore in the balance chamber head and the rod, and a second section disposed between the balance chamber head and the rod. A rod wiper is held against the rod by the second section of the second bushing. A rod seal is held against the rod by the first section of the first bushing. An O ring is disposed between the second section of the first bushing and the inner wall of the balance chamber.

### CROSS-REFERENCE TO RELATED APPLICATIONS

This application claims the benefit of priority of U.S. Provisional Application No. 60/763,221 filed Jan. 30, 2006.

### BACKGROUND OF THE INVENTION

The present invention relates generally to valves and more specifically to a dual bushing rod seal.

In cylinder applications, misalignment is a frequent cause of leakage and/or premature seal failure. For example, referring to U.S. Pat. No. 5,769,123, there is illustrated a descale valve with a counterbore machined directly in the hydraulic head which is made of steel. Water would lay in the wiper area near the top of the hydraulic head and oxidize the area where the counterbore was machined. Once the area had oxidized enough, the counterbore could no longer house the wiper and the wiper would fall out of place. With the wiper gone, contaminants are able to damage the main rod seal and backup, and the rod is susceptible to damage from contact with the steel hydraulic head.

### BRIEF SUMMARY OF THE INVENTION

In accordance with an aspect of the present invention, there is disclosed herein a dual bushing rod seal. The dual bushing rod seal is suitably housed in a Hydraulic Balance Chamber Head and comprises a primary bushing and a secondary bushing

An aspect of the present invention is that it accommodates misalignment much better than a single bushing. Misalignment is a frequent cause of leakage and/or premature seal failure in all cylinder applications, such as descale valves as illustrated in U.S. Pat. No. 5,769,123.

Still other objects of the present invention will become readily apparent to those skilled in this art from the following description wherein there is shown and described a preferred embodiment of this invention, simply by way of illustration of at least one of the best modes best suited to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention.

FIG. 1 illustrates a top view of a hydraulic balance chamber head configured in accordance with an example embodiment.

FIG. 2 is a side view along axis Z-Z of FIG. 1.

FIG. 3 is a cutaway view of a descale valve in accordance with an example embodiment.

FIG. 4 illustrates a method in accordance with an example embodiment.

### DETAILED DESCRIPTION OF INVENTION

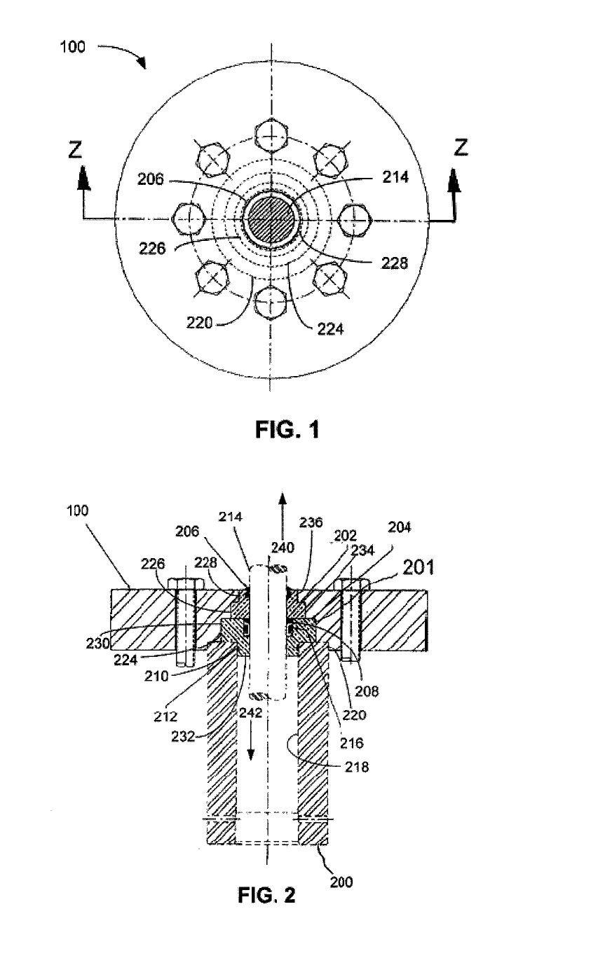

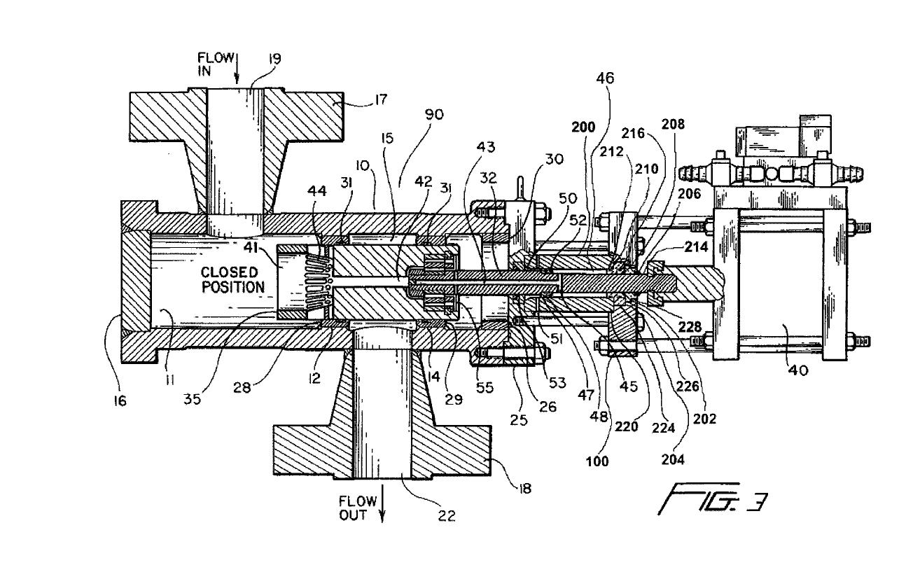

Throughout this description, the preferred embodiment and examples shown should be considered as exemplars, rather than limitations, of the present invention. In accordance with an aspect of the present invention, there is illustrated in FIGS. 1 and 2 a is dual bushing design that accommodates misalignment much better than a single bushing.

Hydraulic balance chamber head 100 is suitably adapted to be mounted on balance chamber piston tube 200. Hydraulic balance chamber head 100 has an opening 201 for receiving dual bushings and a rod (plunger) 214. Balance chamber piston tube 200 has an inner wall 218. Counterbore 220 in balance chamber head 100 aligns hydraulic balance chamber head 100 onto balance chamber piston tube 200. Counterbore 224 in hydraulic balance chamber head 100 retains primary bushing 204 on balance chamber piston tube 200. Counterbore 226 retains secondary bushing 202 over rod 214.

Primary bushing 204 is comprised of two annular sections 230, 232. The first section 230 is configured to be disposed between counterbore 224 of chamber head 100 and rod 214. The second section 232 of primary bushing 204 is configured to be disposed between inner wall 218 of balance chamber piston tube 200 and rod 214.

Secondary bushing 202 is comprised of two annular sections 234 and 236. The first section 234 is configured to be disposed and retained between counterbore 226 of balance chamber head 100 and rod 214. The second section 236 is configured to be disposed and retained between counterbore 228 and rod 214.

Rod wiper 206 is held over rod 214 by section 236 of secondary bushing 202. Rod seal 216 and back up seal 208 in the preferred embodiment are held over rod 214 by section 230 of primary bushing 204. The seal 216 and back up seal 208 are commercially available in kit form. O-ring 212 and Back up ring 210 held in place between wall 218 of balance chamber piston tube 200 and primary bushing 204.

In operation, rod 214 may remain static or function as a plunger and move in either direction 240 or 242. O-ring 212 and back up ring 210 are static seals, and do not move regardless of the operation of rod 214. As rod 214 moves, rod wiper 206, rod seal 216 and back up seal 208 are dynamic seals. As plunger 214 moves, rod wiper 206 is held in place by section 236 of secondary bushing 202, rod seal 216 and back up seal 208 are held in place by section 230 of primary bushing 204.

Using a separate bushing to house rod wiper 206 improves resistance to oxidation with counterbore 228 that holds wiper 206 in place. In a preferred embodiment, rod 214 is a corrosion resistant rod, primary bushing 204 and secondary bushing 202 are made of a bronze alloy or a material with similar properties which will not damage the corrosion resistant material of plunger 214. An additional benefit of using a separate bushing to house rod wiper 206 is that it allows counterbore 228 that holds wiper 206 in place to be machined to much tighter tolerances than when the rod wiper is housed in the hydraulic head itself. An aspect of the present invention is that it allows for a much more robust wiper design. Moreover, because rod seal 216 and back up seal 208 are housed in a separate bushing (Primary Bushing 204), it is easier to change rod seal 216 and back up 208. The dual bushing rod seal is suitable to improve the performance of descale valves such as are illustrated in U.S. Pat. No. 5,769,123 and in FIG. 3.

Referring to FIG. 3, there is illustrated a cylinder actuated descale valve 90 configured in accordance with an aspect of the present invention. As illustrated in FIG. 3 plunger 35 is in the closed position. FIG. 3 further illustrates the valve housing 10, longitudinal opening 11, annular land 12, annular land 14, annularly enlarged chamber 15, disc 16, inlet flange 17, outlet flange 18, inlet port 19, outlet port 22, housing closure plate 25, o-ring seal 26, seal ring 28, seal ring 29, high pressure seal ring 30, high pressure seals 31, operator rod 32, plunger 35, operator means 40, plunger flow opening 41, plunger passage port 42, operator rod passage port 43, plunger flow slots and ports 44, radial actuator rod port 45, balance chamber piston tube 200, piston 47, piston seal 48, actuator rod seal 216, vent chamber 50, vent port 51, retaining nut 52, housing closure plate seal 53, cylinder closure plate 100, operator rod radial port 55, and actuator rod 214.

In a preferred embodiment, descale valve 90 is adapted primarily to control the flow of water under high pressure, typically in the range of 3,000-6,000 P.S.I., to descale hot steel sheets in a steel rolling mill process. Descale valve 90 in preferred form comprises a metal valve body or housing 10 which may be formed as a casting or part casting and part fabrication. The body 10 has a longitudinal opening 11 there through with a pair of machined annular lands 12, 14 between an annularly enlarged chamber 15. One end (the left end as viewed in FIG. 3) of the housing 10 is closed by a metal disc 16 to seal this end opening. Inlet 17 and outlet 18 flanges are connected to the body 10 (on top and bottom respectively as shown in FIG. 3), the inlet flange 17 has an inlet port 19 adapted to be connected to a source of liquid under pressure such as an accumulator and pump and the inlet port 19 communicates with the body opening (at the left-hand side of the body as shown in FIG. 3). The outlet flange 18 has an outlet port 22 adapted to be connected to any desired apparatus, such as high pressure water sprays employed in rolling mills and the outlet port 22 communicates with and is centered within the annularly enlarged chamber 15 within the valve body 10. The opposite end (right-hand end as seen in FIG. 3) of the housing 10 is closed by a closure plate 25 which is secured to the valve body and which is bored through to slidably accept and cooperate with an actuator/operator rod 214. A high pressure seal ring 30 and o-ring seal 26 are disposed within the housing 10 at the closure plate 25 to the seal the closure plate end of the housing. In a preferred embodiment the high pressure seal ring 30 is machined from corrosion resistant metal.

A slidable plunger 35 is positioned for axial reciprocation within the annularly enlarged chamber 15 in the valve housing opening and cooperates with the outlet port 22 and comprises a hollow metal cylinder wherein the external surface of the plunger 35 has a very slight operating clearance with the machined inter-diameter of the housing and a pair of seal rings and a pair of high pressure seals are disposed between the plunger and inter-diameter of the housing at the outlet port so that the plunger slides freely over the outlet port with the seal rings and seals sealing against fluid passages in both directions. The seals 31 act as bearings to prevent metal to metal contact and also act as wipers to keep away contaminates. Suitable seals 31 are commercially available.

The plunger 35 is shifted axially by the operator engaging an actuator rod 214 hydraulic cylinder or mechanical type screw/hand wheel mechanism or other operating means which provides the necessary force to overcome the seal friction and flow path resistance and move the plunger 35 from closed balanced position to open balanced position, or any balanced position in between open and closed.

The plunger 35 has a flow opening 41 at one end (the left end as shown in FIG. 3) and a passage port axially through the plunger which allows the system fluid to exert pressure at the plunger flow opening and to flow through the plunger and an operator rod is disposed at the other end of the plunger (the right end as shown in FIG. 3) with a passage port axially through and ports radially through the operator rod which allows the system fluid to flow from the passage port of the plunger and valve housing through the passage port of the operator rod and into a balance chamber 46 formed in a piston cylinder disposed at the other end of the operator rod 214. An annularly enlarged chamber is formed within the valve housing at the outlet port to allow the system fluid to flow through the outlet port when the plunger is in open balanced position and a plurality of plunger flow slots and holes are disposed between the plunger flow opening and body of the plunger and communicate with and allow the system fluid to flow through the outlet port when the plunger is in open balanced position.

A piston cylinder tube 200 is perpendicular to and secured to the housing closure plate 25 and extends axially therefrom and is adapted to slidably accept the operator rod 214 and an activator rod for axial reciprocation within the piston cylinder tube 200. The piston cylinder tube 200 is closed at one end (the left end as shown in FIG. 3) by the valve housing closure plate 25 and on the other end (the right end as shown in FIG. 3) by a cylinder closure plate 100 which is bored through to slidably accept the actuator rod 214 therethrough.

The operator rod 32 and actuator rod 214 in construction can be one rod with a larger diameter at one end (the left end as shown in FIG. 3) which forms the operator rod 32 and a reduced diameter at the other end (the right end as shown in FIG. 3) which forms the actuator rod 214. The actuator rod 214 and operator rod 32 are positioned to slide axially for reciprocation within the piston cylinder tube 200, the inter-diameter of the piston cylinder tube 200 is uniform and has a very slight operating clearance with the external surface of the piston 47. The reduction in diameter of the actuator rod 214 and the outer-diameter of the piston 47 and cylinder 200 form a balance chamber 46 at the actuator rod end of the cylinder (the right end as shown in FIG. 3) and the operating rod passage port radially through the operator rod extends radially slightly past the juncture of the diameter change of the rod and longitudinally into the actuator rod 214 and radial ports 45 are formed at the end of the operator rod passage port 43 and communicate with the balance chamber 46 and operator rod passage port 43.

Dual bushings 202, 204 are employed to seal the actuator rod 214 at cylinder closure plate 100. O-ring 212 is held in place between bushing 204 and the inner wall of balance chamber 46. Optionally, a back up ring can also be employed. Back up ring 210 is held in place between bushing 204 and the inner wall of balance chamber 46. Rod seal 216 is held against rod 214 by primary bushing 204. Optionally, a back up seal 208 can also be employed. Backup seal 208 is held against rod 214 by primary bushing 204. Rod seal 216 and back up seal 208 are commercially available similar to seal 31. Rod wiper 206 is held against rod 214 by bushing 202. Cylinder closure plate 100 has four counterbores 220, 224, 226 and 228. Counterbore 220 aligns cylinder closure plate 100 with balance chamber 46. Counterbore 224 retains bushing 204 and holds bushing 204 against rod 214. Counterbores 226, 228 retain bushing 202 and hold bushing 202 against rod 214.

In operation the system fluid flows through the plunger 35 and valve housing 10, through the operator rod passage port 43, through the radial ports 45, and into the balance chamber 46 of the piston cylinder tube 200 and applies pressure against a piston cylinder disposed within the piston cylinder tube 200 and base against the external surface of the either operator rod 32 and/or actuator rod 214 at the point of reduced diameter of the actuator rod 214 and balances the pressure exerted by the fluid system on the increased diameter of the operating rod 32 and holds the plunger 35 in a balanced position continuously. A vent chamber 50 is formed by the tolerance between the external surface of the operator rod 32 and the inter-diameter of the piston cylinder tube 200 and a vent port 51 extends radially through the piston cylinder tube 200 and cooperates with and exhausts the vent chamber 50 on movement of the piston 47. A retaining nut 52 is disposed on the actuator rod 214 to secure and bias the piston 47 against the operator rod 32. A housing closure plate seal 53 is disposed at the housing closure plate 25 of the piston cylinder tube 200 to seal the cylinder at one end. Additional seals are disposed between the actuator rod 214 and the cylinder closure plate 100 at the other end of the cylinder to seal the cylinder at that end as described herein. The diameter of the operator rod 32 and the reduced diameter of the actuator rod 214 are selected so that the balance chamber within the piston cylinder tube is formed of appropriate size to provide the appropriate force to balance the entire system and provide for complete and continuous balancing of the plunger in any desired position irrespective of system pressure.

Actuator rod 214 extends through the cylinder closure plate 100 and operator means 40 is secured to one end of the actuator rod 214 (the right end as shown in FIG. 3) to slidably move the plunger 35 to open and close positions as desired.

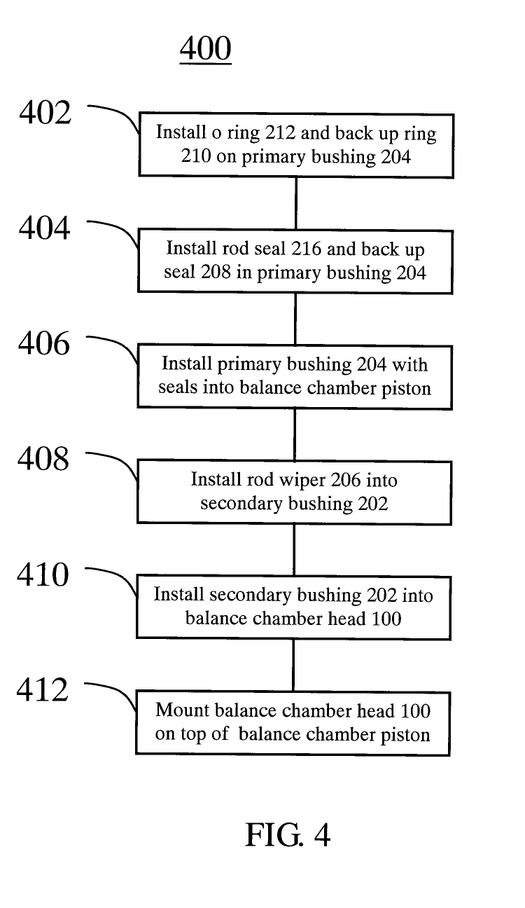

In view of the foregoing structural and functional features described above, a methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

Methodology 400 is a method for providing a seal between a plunger rod and a chamber head configured to be mounted on a chamber. The seal as described herein comprises a primary and secondary bushing. The chamber head has counterbores for holding the bushings in place when it is mounted on the chamber.

At 402, an O ring, and if desired a back up ring, are installed. Referring to FIG. 2 with continued reference to FIG. 4, the O ring and back up ring are installed so that they are disposed between a primary bushing and the wall of the chamber

At 404, a rod seal, and if desired a back up seal, are installed between the first bushing and the rod. The first bushing holds the rod seal and back up seal against the rod for sealing the rod. If the rod moves (e.g. like a plunger), the rod seal and back up seal provide a dynamic seal.

At 406, the first (primary) bushing is installed. The bushing is installed around the rod (plunger). In a preferred embodiment, the primary bushing has two sections, one section is configured to fit between the rod and the chamber wall and the other section is configured to fit between the chamber head and the rod. After installation of the first bushing, the O ring and back up ring are disposed between the bushing (e.g. the first section of the bushing in a preferred embodiment) and the chamber wall.

At 408, a rod wiper is inserted into the secondary bushing 202 and operates between the second bushing and the rod. The second bushing holds the rod wiper against the rod. When the rod is moving, the wiper forms a dynamic seal.

At 410, a second (secondary) bushing is installed. The second bushing in a preferred embodiment is installed around the rod and on adjacent to (e.g. on top of) the first bushing. In a preferred embodiment, the second bushing comprises two sections, the first section adjacent to the first bushing and the second section configured to hold a rod wiper.

At 412, the balance chamber head is mounted on top of the chamber. In a preferred embodiment, the balance chamber head has a first counterbore for receiving the first section of the first bushing and a second counterbore for receiving the second bushing. The chamber head holds the first and second bushings against the rod. In a preferred embodiment, the balance chamber head comprises a third counterbore for aligning the chamber head with the chamber.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations.

What is claimed is:

1. An apparatus, comprising:
a balance chamber having an inner wall;
a rod
a balance chamber head configured to be mounted on the balance chamber, the balance chamber head comprising an opening for receiving the rod, a first grove for aligning the balance chamber head with the balance chamber, and a second counterbore;
a first bushing, comprising two sections, the first section disposed between the rod and the first counterbore of the balance chamber head and the second section disposed between the rod and the inner wall of the balance chamber;
a second bushing comprising two sections, the first section disposed between the second counterbore of the balance chamber head and the rod, the second section disposed between the balance chamber head and the rod;
a rod wiper held against the rod by the second section of the second bushing;
a rod seal held against the rod by the first section of the first bushing; and
an O ring disposed between the second section of the first bushing and the inner wall of the balance chamber.

2. The apparatus of claim 1, the balance chamber head further comprising a third counterbore for aligning the balance chamber head with the balance chamber.

3. The apparatus of claim 1, further comprising a backup rod seal held against the rod by the first section of the first bushing.

4. The apparatus of claim 1, further comprising a backup ring disposed between the second section of the first bushing and the inner wall of the balance chamber;

5. The apparatus of claim 1, wherein the rod is made of corrosion resistant metal, the first and second bushings are made of a bronze alloy.

6. The apparatus of claim 1, further comprising:
a backup rod seal held against the rod by the first section of the first bushing; and
a backup ring disposed between the second section of the first bushing and the inner wall of the balance chamber.

7. The apparatus of claim 6, wherein the rod is made of steel, the first and second bushings are made of a bronze alloy.

8. A valve for controlling the flow of liquid under pressure, comprising:
a valve housing, having a longitudinal opening which is closed at both ends;
a disc closing the valve housing at one end;
inlet and outlet ports communicating with said housing opening at longitudinally spaced places therealong;
a valve plunger slidably received within said housing opening and recipricable axially thereof, said plunger being in the form of a tubular cylinder with a flow opening at one end and cooperating with the flow of liquid through the inlet port and a plurality of flow slots and ports disposed in the defining wall of said plunger and cooperating with the said outlet port, whereby in one position said plunger communication between said inlet and outlet ports is blocked, and in the other plunger position communication between said inlet and outlet ports is effected, a plunger passage port longitudinally through said plunger to allow the flow of liquid through said flow opening, said flow slots and ports, and through said plunger so that the fluid communicates with both ends of said plunger and biases said plunger in any position;
a two-ended operator rod with one end extending into said opposite end of said plunger for effecting shifting action of said plunger to selected positions and permitting substantially unrestricted flow of liquid through and out said opposite end of said plunger and out to surround the exterior of said plunger at said opposite end and thereby provide a balancing effect to minimize liquid resistance to plunger shifting action and the other end of said operator rod extending perpendicular to and through a housing plate sealing the opposite end of the valve housing and through a piston cylinder tube disposed axially from said housing closure plate, and said operator rod having a passage port longitudinally through said operator rod and communicating with the passage port of the plunger and the piston cylinder tube and said operator rod having a plurality of radial ports communicating with said operator rod passage port to allow said fluid to flow from said opposite end of said plunger through said radial ports and through said operator rod passage port and cooperating therewith,
said housing plate disposed at said opposite end of said housing to seal said opposite end of said housing and adapted to slidably accept said operator rod through said housing closure plate, said housing plate comprising a first counterbore and a second counterbore;
a first bushing, comprising two sections, the first section disposed between the plunger and the first counterbore of the housing plate and the second section disposed between the plunger and the valve housing;
a second bushing comprising two sections, the first section disposed between the second counterbore of the housing plate and the plunger, the second section disposed between the housing plate and the plunger;
a rod wiper held against the plunger by the second section of the second bushing;
a rod seal held against the plunger by the first section of the first bushing; and
an O ring disposed between the second section of the first bushing and the valve housing;
a pair of circular lands on the inter-wall surface of said valve housing being spaced apart and disposed on opposite sides of said outlet port and cooperating with the exterior surface of said plunger;
an annularly enlarged chamber formed in said valve housing between said pair of lands,
a pair of seals disposed between said pair of lands and the exterior surface of said plunger to seal and prevent fluid flow from said inlet port to said outlet port except through the cylinder plunger;
said piston cylinder tube disposed axially from said housing closure plate having a longitudinal opening of substantially uniform interior diameter along its entire length and closed at one end by said housing closure plate and closed at the opposite end by a cylinder closure plate and said cylinder piston tube adapted to slidably accept said operator rod and an actuator rod reciprocally axially thereof and within said piston cylinder tube;
said actuator rod of smaller diameter than said operator rod and at one end extending axially from said opposite end of said operator rod within said piston cylinder tube and extending perpendicular to and through said cylinder closure plate, and providing for said operator rod passage port extending slightly longitudinally into said actuator rod and cooperating with said operator rod passage port, and a plurality of actuator rod radial ports disposed in said actuator rod and cooperating with said operator rod passage port and to allow the flow of fluid continuously through said plunger, said operator rod and said actuator rod and into said piston cylinder tube;
a balancing chamber formed within said piston cylinder tube between the exterior surface of said actuator rod and the interior surface of said piston cylinder tube and cooperating with actuator rod radial ports and to allow the flow of fluid into said piston cylinder tube and to communicate with and completely balance the pressure against both ends of the said plunger and to keep said plunger in a balanced condition in any position;
a piston disposed at the juncture of said operator rod and said activator rod adapted to slide within said piston cylinder tube and to effect positioning of said plunger;
a retaining nut disposed on said actuator rod to bias and secure said piston against said operator rod;
a vent chamber disposed between the exterior surface of said operator rod and the interior surface of said piston cylinder tube and a plurality of radial vent ports cooperating with said vent chamber to exhaust air to the atmosphere in the slidable stroke of the said piston;
said cylinder closure plate disposed at the opposite end of said cylinder piston tube to seal said cylinder piston tube and bored to slidably accept said actuator rod perpendicularly and through said cylinder closure plate;
activator rod seals disposed within said piston cylinder tube at said cylinder closure plate end to seal said cylinder closure plate to said piston cylinder tube; and
an operator means disposed at the opposite end of said actuator rod to urge said plunger to selected position.

9. The valve of claim 8 wherein the larger diameter of said operating rod and smaller diameter of said actuator rod are predetermined and correlated to provide continuous balance of said plunger in any position.

10. The valve of claim 8 wherein the liquid under pressure may attain a pressure of 6,000 P.S.I.

11. The valve of claim 8, further comprising a backup rod seal held against the rod by the first section of the first bushing.

12. The valve of claim 8, further comprising a backup ring disposed between the second section of the first bushing and the inner wall of the balance chamber;

13. The valve of claim 8, wherein the rod is made of steel, the first and second bushings are made of a bronze alloy.

14. The valve of claim 8, further comprising:
a backup rod seal held against the rod by the first section of the first bushing; and
a backup ring disposed between the second section of the first bushing and the inner wall of the balance chamber.

15. The valve of claim 14, wherein the rod is made of steel, the first and second bushings are made of a bronze alloy.

16. A method for providing a seal between a plunger rod and a chamber head configured to be mounted on a chamber, comprising:
installing an O ring to be disposed between a wall of the chamber and a first bushing;
installing the first bushing around the plunger, the first bushing having a first section and a second section, such that the second section is disposed between the plunger and the interior wall of the chamber, and the O ring is between the second section of the first bushing and the interior wall of the chamber;
inserting a rod seal between the first section of the first bushing and the plunger rod;
installing a second bushing adjacent to the first bushing;
inserting a rod wiper between the second bushing and the plunger; and
mounting the balance chamber head on top of the chamber, the balance chamber head having a first counterbore for receiving the first section of the first bushing and a second counterbore for receiving the second bushing.

17. A method according to claim 16, wherein the balance chamber head has a third counterbore, the method further comprising aligning the third counterbore of the balance chamber head with the balance chamber.

18. A method according to claim 16, further comprising:
inserting a back up ring and O ring between a wall of the chamber and the second section of the first bushing; and inserting a back up rod seal between the first section of the first bushing and the plunger rod.
